(19) United States
(12) Patent Application Publication
(10) Pub. No.: US 2005/0238827 A1
(43) Pub. Date: Oct. 27, 2005

(54) Ink-jet recording sheet, method for making the same, and image-forming method

(75) Inventor: Tetsuo Kozumi, Miyagi (JP)

Correspondence Address: ROBERT J. DEPKE;LEWIS T. STEADMAN, TREXLER, BUSHNELL, GLANGLORGI, BLACKSTONE & MARR, 105 WEST ADAMS STREET, SUITE 3600, CHICAGO, IL, 60603-6299, US

(73) Assignee: Sony Corporation

(21) Appl. No.: 11/171,106

(22) Filed: Jun. 28, 2005

Related U.S. Application Data
(63) Continuation of application No. 10/384,818, filed on Mar. 10, 2003.

(30) Foreign Application Priority Data
Mar. 12, 2002 (JP) JP2002-067532

(51) Int. Cl. B41M 5/00

(52) U.S. Cl. 428/32.24

(57) ABSTRACT

Disclosed is an ink-jet recording sheet which has excellent glossiness and ink absorbability, improved storage stability of images, such as light fastness and water resistance, and satisfactory coating strength. An ink-jet recording sheet, in which the specular gloss at an angle of 60 degrees according to JIS Z8741 is 50% or more, includes an ink-absorbing layer disposed on a substrate, and a gloss-developing layer disposed on the ink-absorbing layer, the gloss-developing layer being formed by applying a coating compound containing a water-soluble zirconium salt onto the ink-absorbing layer, followed by drying. The content of the water-soluble zirconium salt, in terms of ZrO₂, is 10% by weight or more of the total solids in the coating compound, and the coating compound optionally contains a binder resin in an amount not exceeding the zirconium salt content in terms of ZrO₂.

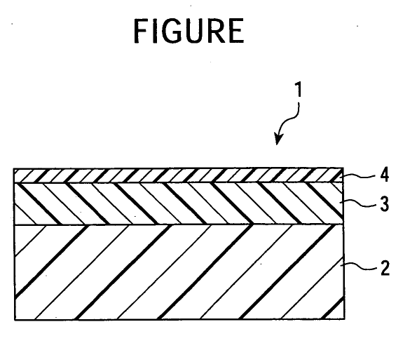

### BACKGROUND OF THE INVENTION

1. Field of the Invention

The present invention relates to an ink-jet recording sheet, for example, used for an image-forming apparatus employing an ink-jet printing method in which ink is ejected from recording nozzles driven by an electric field, heat, pressure, or the like. The invention also relates to a method for making the ink-jet recording sheet and an image-forming method.

2. Description of the Related Art

One example of a method for outputting image information and character-code information created by personal computers onto recording media, such as paper, is an ink-jet printing method, in which images are formed by ejecting ink containing water-soluble dyes or pigments from recording nozzles driven by an electric field, heat, pressure, or the like. Ink-jet printing methods are becoming increasingly common in offices and homes because of low running costs, low noise, and ease in multicolor printing, and also because it is possible to form images on plain paper.

Examples of known ink-jet recording sheets, which are recording media on which images are formed in such ink-jet recording methods, include plain paper, coated paper provided with ink-absorbing layers on the recording surfaces thereof, glossy paper with glossy recording surfaces, and OHP recording sheets including ink-absorbing layers disposed on transparent substrates.

The ink-jet recording sheet must absorb ink rapidly so as to prevent the ink from flowing or bleeding even when printed dots overlap each other. Printed dots must have high density and must be bright and vivid. Lateral diffusion (perpendicular to the traveling direction of the ink-jet recording sheet) of printed dots should be small, the outside edges of the dots must be smooth, and blurring must be prevented. In particular, if the ink-absorbing rate is low, an ink droplet is mixed with another ink droplet before being absorbed by the absorbing layer, and printing irregularities, such as crawling and bleeding, may occur, resulting in a large decrease in image quality. Therefore, the recording sheet must have high ink absorbability.

In order to meet the requirements described above, various techniques have been proposed. For example, Japanese Unexamined Patent Application Publication No. 52-53012 discloses a recording sheet in which a small size base paper is moistened with a coating material for surface treatment. Japanese Unexamined Patent Application Publication No. 55-5830 discloses a recording sheet in which an ink-absorbing coating layer is provided on a surface of a substrate. Japanese Unexamined Patent Application Publication No. 56-157 discloses a recording sheet in which a coating layer contains noncolloidal silica powder as a pigment. Japanese Unexamined Patent Application Publication No. 57-107878 discloses a recording sheet in which a combination of an inorganic pigment and an organic pigment is used. Japanese Unexamined Patent Application Publication No. 58-110287 discloses a recording sheet exhibiting two pore distribution curves. Japanese Unexamined Patent Application Publication No. 62-111782 discloses a recording sheet including upper and lower porous layers. Japanese Unexamined Patent Application Publication Nos. 61-135786, 61-148092, 62-149475, etc., disclose recording sheets including impalpable powder layers. Japanese Unexamined Patent Application Publication Nos. 63-252779, 1-108083, 2-136279, 3-65376, 3-27976, etc., disclose recoding sheets containing pigments or fine silica particles having specific physical properties. Japanese Unexamined Patent Application Publication Nos. 57-14091, 60-219083, 60-210984, 61-20797, 61-188183, 5-278324, 6-92011, 6-183134, 7-137431, 7-276789, etc., disclose recording sheets containing fine silica particles, such as colloidal silica. Japanese Unexamined Patent Application Publication Nos. 2-276671, 3-67684, 3-215082, 3-251488, 4-67986, 4-263983, 5-16517, etc., disclose recording sheets containing fine alumina hydrate particles.

Recently, instead of silver halide photographs, outputting of high-quality image data recorded by digital cameras or the like using the ink-jet recording method has been widely used. As a result, glossiness as high as that in silver halide photographs is required for ink-jet recording sheets.

However, in most of the ink-jet recording sheets described above, in order to ensure ink absorbability, the ink-absorbing layers have porous void structures mainly composed of inorganic fillers. Consequently, it is fundamentally difficult to increase glossiness, and images printed on the ink-jet recording sheets do not have high glossiness like silver halide photographs.

In order to produce silver halide photograph-like glossiness in ink-jet recording sheets, an attempt has been made to mirror finish the surface of the ink-absorbing layer by a casting method or film transfer method. However, glossiness of the resultant recording sheets is far from comparable to silver halide photographs. Other disadvantages are in that substrates are limited to absorptive bases, such as paper, and that operating performance is degraded.

In another attempt, a gloss-developing layer composed of an inorganic pigment or the like having a smaller particle size than that of an inorganic pigment used for an ink-absorbing layer and exhibiting weak agglomeration is provided on the ink-absorbing layer. The surface properties of the ink-jet recording sheet is improved, resulting in an improvement in glossiness. However, since the porosity of the gloss-developing layer is greatly lower than that of the ink-absorbing layer, the hit ink cannot permeate into the ink-absorbing layer at a satisfactory rate. As a result, the image quality is greatly degraded, and thus such an ink-jet recording sheet is not practical for use.

Additionally, with respect to the ink-jet recording sheet, the obtained images must be clear for a long period of time, i.e., the ink-jet recording sheet must have excellent storage stability. For example, high light-fastness is required so that printed images do not easily fade or discolor even if exposed to light for a long period of time. High moisture resistance is required so that printed images do not bleed even if exposed to high humidity for a long period of time. High water resistance is required so that printed images do not bleed or fade even if the printed images are exposed to water by mistake.

In order to meet the requirements described above, many ink-jet printing sheets including zirconium compounds have been proposed. As a method for making an ink-jet printing sheet in which a zirconium compound is directly added to an ink-absorbing layer, for example, Japanese Unexamined Patent Application Publication No. 4-7189 discloses a method for making a recording medium provided with an ink-absorbing layer containing a porous pigment and a zirconium oxychloride-based inorganic polymer. Japanese Unexamined Patent Application Publication No. 6-32046 discloses an ink-jet recording sheet including an ink-absorbing layer containing predetermined amounts of amorphous silica, a vinyl alcohol copolymer having a silanol group, and a zirconium compound. Japanese Unexamined Patent Application Publication No. 2000-71609 discloses an ink-jet recording sheet containing an alumina hydrate having a boehmite structure and a zirconium compound having non-coupling properties. As a method for making an ink-jet printing sheet in which a glossy layer containing a zirconium compound is disposed on an ink-absorbing layer, for example, Japanese Unexamined Patent Application Publication No. 2001-219644 discloses an ink-jet recording sheet including a zirconium compound and a resin capable of forming a crosslinked structure by reacting with the zirconium compound.

However, in the case of the ink-jet recording sheet in which a zirconium compound is directly added to an ink-absorbing layer, although coating strength can be improved, glossiness is not substantially improved and it is not possible to obtain glossiness comparable to silver halide photographs. Moreover, satisfactory ink absorbability and image storage stability are not obtained. In the case of the ink-jet recording sheet in which a glossy layer containing a zirconium compound is disposed on an ink-absorbing layer, glossiness comparable to silver halide photographs is not obtained, and ink absorbability is insufficient.

As described above, characteristics required for ink-jet recording sheets include glossiness, ink absorbability, image storage stability, such as light fastness and water resistance, coating strength, etc. None of the conventional ink jet recording sheets satisfies all of the requirements described above.

### SUMMARY OF THE INVENTION

It is an object of the present invention to provide an ink jet recording sheet having excellent glossiness and ink absorbability, improved image storage stability, such as light fastness and water resistance, and satisfactory coating strength.

In one aspect of the present invention, an ink-jet recording sheet includes an ink-absorbing layer disposed on a substrate, and a gloss-developing layer disposed on the ink-absorbing layer, the gloss-developing layer containing a water-soluble zirconium salt as a principal ingredient. The content of the water-soluble zirconium salt, in terms of ZrO₂, is 10% by weight or more of the total solids in the gloss-developing layer, and the gloss-developing layer optionally contains a binder resin in an amount not exceeding the zirconium salt content in terms of ZrO₂.

From the point of view of a coating compound containing a water-soluble zirconium salt for forming a gloss-developing layer, an ink-jet recording sheet of the present invention is described as below.

That is, in another aspect of the present invention, an ink-jet recording sheet includes an ink-absorbing layer disposed on a substrate, and a gloss-developing layer disposed on the ink-absorbing layer, the gloss-developing layer being formed by applying a coating compound containing a water-soluble zirconium salt onto the ink-absorbing layer, followed by drying. The content of the water-soluble zirconium salt, in terms of ZrO₂, is 10% by weight or more of the total solids in the coating compound, and the coating compound optionally contains a binder resin in an amount not exceeding the zirconium salt content in terms of ZrO₂.

In another aspect of the present invention, a method for making an ink-jet recording sheet includes the steps of applying a coating solution onto a substrate, followed by drying, to form an ink-absorbing layer; and applying a coating compound containing a water-soluble zirconium salt onto the ink-absorbing layer, followed by drying to form a gloss-developing layer, the content of the water-soluble zirconium salt, in terms of ZrO₂, being 10% by weight or more of the total solids in the coating compound, the coating compound optionally containing a binder resin in an amount not exceeding the zirconium salt content in terms of ZrO₂.

In another aspect of the present invention, an image-forming method includes a step of forming an image on an ink-jet recording sheet by ink-jet recording from a gloss-developing layer side, the ink-jet recording sheet including an ink-absorbing layer disposed on a substrate and the gloss-developing layer disposed on the ink-absorbing layer, the gloss-developing layer containing a water-soluble zirconium salt as a principal ingredient, the content of the water-soluble zirconium salt, in terms of ZrO₂, being 10% by weight or more of the total solids in the gloss-developing layer, the gloss-developing layer optionally containing a binder resin in an amount not exceeding the zirconium salt content in terms of ZrO₂.

From the point of view of a coating compound containing a water-soluble zirconium salt for forming a gloss-developing layer, an image-forming method of the present invention is described as below.

That is, an image-forming method includes a step of forming an image on an ink-jet recording sheet by ink-jet recording from a gloss-developing layer side, the ink-jet recording sheet including an ink-absorbing layer disposed on a substrate and the gloss-developing layer disposed on the ink-absorbing layer, the gloss-developing layer being formed by applying a coating compound containing a water-soluble zirconium salt onto the ink-absorbing layer, followed by drying, the content of the water-soluble zirconium salt, in terms of ZrO₂, being 10% by weight or more of the total solids in the coating compound, the coating compound optionally containing a binder resin in an amount not exceeding the zirconium salt content in terms of ZrO₂.

### BRIEF DESCRIPTION OF THE DRAWINGS

FIGURE is a sectional view of an ink-jet recording sheet of the present invention.

### DESCRIPTION OF THE PREFERRED EMBODIMENTS

The present invention will be described in detail below. FIGURE is a sectional view of an ink-jet recording sheet in an embodiment of the present invention. An ink-jet recording sheet 1 includes a substrate 2, a porous ink-absorbing layer 3 disposed thereon for absorbing inks and fixing pigments, and a gloss-developing layer 4 disposed further thereon as a surface layer. Herein, the surface layer is an outermost layer of the side on which an image is formed and recorded, and the gloss-developing layer 4 as the surface layer is capable of absorbing inks and making the inks permeate into the ink-absorbing layer 3 beneath.

In the present invention, the gloss-developing layer 4 contains a water-soluble zirconium salt as a principal ingredient and is formed by applying a coating compound containing a water-soluble zirconium salt to the ink-absorbing layer 3, followed by drying.

Examples of the water-soluble zirconium salt also include a zirconium compound which is modified by a chemical reaction, such as decarboxylation, when the gloss-developing layer 4 is formed, e.g., zirconium hydroxide.

Any zirconium salt which dissolves in water at ambient temperature may be used. Examples of the water-soluble zirconium salt include halide salts, such as zirconium oxychloride and Zr₂O₃Cl₂; organic acid salts, such as zirconium acetate, zirconium stearate, zirconium octylate, and zirconium laurate; oxo acid salts, such as zirconium carbonate, zirconium sulfate, zirconium nitrate, and ammonium zirconium carbonate. These compounds may be used alone or as a mixture of two or more thereof. Additionally, if a water-insoluble zirconium salt is used, the glossiness of the ink-jet recording sheet-becomes insufficient and the coating strength of the gloss-developing layer becomes insufficient, which are undesirable.

Among the water-soluble zirconium salts described above, a water-soluble zirconium salt of the oxo acid is more preferable because of its excellent ink absorbability and because glossiness of the ink-jet recording sheet can be further improved. Most preferably, ammonium zirconium carbonate, potassium zirconium carbonate, or zirconium nitrate is used. In view of the pH, a water-soluble zirconium salt whose aqueous solution is alkaline is preferred. For example, ammonium zirconium carbonate has a pH of 9, and potassium zirconium carbonate has a pH of 10. Zirconium nitrate has a pH of 2.1.

The content of the water-soluble zirconium salt, in terms of ZrO₂, is 10% by weight or more, and more preferably 50% by weight or more of the total solids (i.e., the water-soluble zirconium salt, a binder resin, an inorganic pigment, etc.), and may be 100% by weight. If the content of the water-soluble zirconium salt is less than 10% by weight of the total solids, the glossiness of the ink-jet recording sheet becomes insufficient and the storage-stability-improving effect becomes insufficient.

The content of a binder resin in the gloss-developing layer 4 must be in the range of 0 to the amount not exceeding the water-soluble zirconium salt content in terms of ZrO₂. If the binder resin content exceeds the water-soluble zirconium salt content, the glossiness of the ink-jet recording sheet becomes insufficient, and ink absorbability is also impaired, which are undesirable.

From the point of view of a coating compound containing a water-soluble zirconium salt for forming the gloss-developing layer 4, the content of the water-soluble zirconium salt, in terms of ZrO₂, is 10% by weight or more, and preferably 50% by weight or more of the total solids, and may be 100% by weight. The content of a binder resin in the coating compound must be in the range of 0 to the amount not exceeding the water-soluble zirconium salt content in terms of ZrO₂.

Examples of a binder resin which can be incorporated into the gloss-developing layer 4 or the coating compound containing the water-soluble zirconium salt include polyvinyl alcohol, polyvinyl acetal, polyvinyl pyrrolidone, cellulose derivatives, such as carboxymethyl cellulose and methylcellulose, various types of starches, such as starch and oxidized starch, proteins, such as casein and soybean protein, acrylic resins, acrylic polymer latices, styrene-butadiene copolymers, ethylene-vinyl acetate copolymers, and polyurethane resins, which are known resins commonly used for coated papers. These resins may be used alone or in combination. Above all, polyvinyl alcohol is preferably used.

In addition to the water-soluble zirconium salt and the binder resin, an inorganic pigment which improves ink absorbability and improves the density and color saturation of images may be incorporated into the gloss-developing layer 4 or the coating compound containing the water-soluble zirconium salt. Examples of the inorganic pigment includes amorphous silica, such as silica produced by a precipitation method, silica produced by a gel method, colloidal silica, and silica produced by a vapor phase process (fumed silica), and-alumina-produced by a vapor phase process (fumed alumina). Preferably, the inorganic pigment has an average primary particle size of 0.15 μm or less and an average secondary particle size of 5 μm or less so that glossiness is not adversely affected.

The content of the inorganic pigment in the gloss-developing layer 4 or the coating compound containing the water-soluble zirconium salt is preferably 50% by weight or less, and more preferably 15 to 40% by weight of the total solids in view of improvement in glossiness in the present invention. If the content exceeds 50% by weight, glossiness becomes unsatisfactory, and the coating strength of the gloss-developing layer 4 is decreased.

Additionally, various auxiliary agents may be incorporated into the gloss-developing layer 4 or the coating compound containing the water-soluble zirconium salt. Examples thereof are ink-fixing agents, pigment-dispersing agents, thickening agents, singlet oxygen quenchers, hindered amine light stabilizers, antioxidants, defoaming agents, ultraviolet absorbing agents, fluorescent whitening agents, water-resisting agents, discoloration prevention agents, antistatic agents, and mildew proofing agents. Above all, an ink-fixing agent is preferably added as an auxiliary agent in order to impart water resistance to printed images. As the ink-fixing agent, preferably, a cationic inorganic substance is used, and more preferably, a cationic organic substance is used. Examples of cationic organic substances include polyethylene imines, polyethylene amines, polypropylene polyamines, polyvinyl amines, polyamine sulfones, polyaminepolyamide epichlorohydrins, poly(dimethyldiallyl-ammonium chloride), poly(dimethyldiallyl ammonium chloride)-SO₂ copolymers, diallylamine salt-SO₂ copolymers, dicyandiamide-diethylenetriamine polycondensates, and dicyandiamide-formaldehyde polycondensates.

The coating compound containing the water-soluble zirconium salt may also contain water or a water-miscible organic solvent.

In order to form the gloss-developing layer 4, the coating compound containing the water-soluble zirconium salt is applied to the substrate 2, for example, by roll coating, blade coating, air-knife coating, rod-bar coating, gravure coating, comma coating, or die coating, followed by drying as required.

The gloss-developing layer 4 is formed by applying the coating compound containing the water-soluble zirconium salt preferably at a rate of 0.05 to 4.5 g/m², and more preferably 0.1 to 2 g/m², on dry weight basis. If the coating amount is less than 0.05 g/m² or exceeds 4.5 g/m², glossiness is decreased. In particular, if the coating amount is less than 0.05 g/m², storage stability of images is degraded.

The gloss-developing layer 4 as the surface layer described above has high glossiness and excellent storage stability of images. The gloss-developing layer 4 as the surface layer does not inhibit inks from permeating into the ink-absorbing layer 3 beneath and has excellent ink absorbability. Consequently, the gloss-developing layer 4 corresponds to a glossy paper which is substantially similar to or equal to a silver halide photograph, i.e., the specular gloss at an angle of 60 degrees according to Japanese Industrial Standard (JIS) Z8741 is 50% or more, and preferably 70% or more.

Additionally, the boundary between the gloss-developing layer 4 and the ink-absorbing layer 3 is not specifically defined, and a region in which the gloss-developing layer 4 and the ink-absorbing layer 3 are mixed with each other is formed. In such a region, the water-soluble zirconium salt in the gloss-developing layer 4 and a part of the binder resin in the ink-absorbing layer 3 are considered to be crosslinked.

The substrate 2 and the ink-absorbing layer 3 of the ink-jet recording sheet will now be described.

As the substrate 2, any known substrate may be used. Examples thereof include a paper substrate composed of a raw material for pulp, containing natural cellulose fiber as a principal ingredient; plastic substrates composed of polyesters (e.g., polyethylene terephthalate), cellulose triacetate, polycarbonate, polyvinyl chloride, polypropylene, polyimides and the like; and a resin-coated paper (e.g., RC paper) including a polyolefin resin-coated layer in which a white pigment, etc., is added to at least one side of the base paper. In order to obtain clear images with higher densities, a hydrophobic substrate into which an ink solution does not permeate, that is, a plastic substrate or resin-coated paper is preferably used. In order to obtain a much more silver halide photograph-like ink-jet printing sheet, a resin-coated paper is preferably used.

The weighing capacity of the substrate 2 is preferably 75 to 350 g/m² and more preferably 100 to 300 g/m².

Additionally, in order to improve adhesion with the ink-absorbing layer 3, the surface of the substrate 2 on which the ink-absorbing layer 3 is formed may be coated with a known anchoring agent as necessary, or may be treated by plasma discharging.

The ink-absorbing layer 3 is composed of an ink-absorbable pigment, a binder resin, and various auxiliary agents.

Examples of the auxiliary agents incorporated into the ink-absorbing layer 3 include ink fixing agents, pigment-dispersing agents, thickening agents, singlet oxygen quenchers, hindered amine light stabilizers, antioxidants, defoaming agents, ultraviolet absorbing agents, fluorescent whitening agents, water-resisting agents, discoloration prevention agents, antistatic agents, and mildew proofing agents. Above all, an ink-fixing agent is preferably added as an auxiliary agent in order to impart water resistance to printed images. As the ink-fixing agent, preferably, a cationic inorganic substance is used, and more preferably, a cationic organic substance is used. Examples of cationic organic substances include polyethylene imines, polyethylene amines, polypropylene polyamines, polyvinyl amines, polyamine sulfones, polyaminepolyamide epichlorohydrins, poly(dimethyldiallyl-ammonium chloride), poly(dimethyldiallyl ammonium chloride)-SO₂ copolymers, diallylamine salt-SO₂ copolymers, dicyandiamide-diethylenetriamine polycondensates, and dicyandiamide-formaldehyde polycondensates.

As the ink-absorbable pigment constituting the ink-absorbing layer 3, any known pigment may be used. Examples thereof include soft calcium carbonate, heavy calcium carbonate, magnesium silicate, aluminum silicate, colloidal silica, colloidal alumina, barium sulfate, calcium sulfate, satin white, clay, synthetic amorphous silica, alumina, titanium dioxide, kaoline, magnesium hydroxide, pseudoboehmite, magnesium carbonate, zinc oxide, mica, and zinc sulfate. These substances may be used alone or in combination. In particular, porous synthetic amorphous silica or porous alumina having a large pore volume is preferably used. Fine silica particles synthesized by a vapor phase process or fine alumina particles synthesized by a vapor phase process are more preferably used, which can be relatively easily formed into fine particles close to primary particles and can provide an ink-absorbing layer with a high porosity.

Examples of a binder resin which can be incorporated into the ink-absorbing layer 3 include polyvinyl alcohol, polyvinyl pyrrolidone, polyvinyl acetal, cellulose derivatives, such as carboxymethyl cellulose and methylcellulose, various types of starches, such as starch and oxidized starch, proteins,. such as casein and soybean protein, acrylic resins, melamine resins, acrylic polymer latices, styrene-butadiene copolymers, ethylene-vinyl acetate copolymers, and polyurethane resins, which are known resins commonly used for coated papers. These resins may be used alone or in combination. Above all, a reactive water-soluble resin is preferably used because of its excellent gloss-improving effect and coating strength-improving effect. Although the reasons for improvement in coating strength are uncertain, the water-soluble resin which is present on the surface of the ink-absorbing layer 3 and which is reactive with water-soluble zirconium salts is considered to react with the water-soluble zirconium salt in the gloss-developing layer 4 to form a crosslinked structure, resulting in an improvement in coating strength.

The content of the reactive water-soluble resin in the ink-absorbing layer 3 is preferably 80% by weight or more of the total resins used in the ink-absorbing layer 3 in order to ensure sufficient glossiness and coating strength.

As the water-soluble resin which is reactive with the water-soluble zirconium salt, any resin with a functional group, such as a hydroxyl group, carboxyl group, or methylol group, may be used. Examples thereof include polyvinyl alcohol, polyvinyl acetal, acrylic resins, polyamides, and melamine resins. In particular, polyvinyl alcohol is preferably used because of its excellent gloss-improving effect and coating strength-improving effect.

In order to form the ink-absorbing layer 3, a coating solution for the ink-absorbing layer prepared by dissolving or dispersing the ingredients described above in water or a proper solvent is applied to the substrate 2, for example, by roll coating, blade coating, air-knife coating, rod-bar coating, gravure coating, comma coating, or die coating, followed by drying.

The coating amount of the ink-absorbing layer 3 may be appropriately determined and is preferably 10 to 40 g/m², and more preferably 15 to 30 g/m².

The ink-jet recording sheet 1 shown in FIGURE may be fabricated by applying a coating solution for the ink-absorbing layer by comma coating or the like to the surface of the substrate 2, for example, composed of a resin-coated paper provided with a polyolefin-coated layer, followed by drying, to form the ink-absorbing layer 3, and by applying a coating compound containing the water-soluble zirconium salt to the ink-absorbing layer 3, followed by drying to form the gloss-developing layer 4.

The ink-absorbing layer 3 may be remoistened by applying a remoistening solution to the surface thereof before the coating compound containing the water-soluble zirconium salt is applied to the ink-absorbing layer 3. Consequently, glossiness is improved. As the remoistening solution, water or a highly volatile solvent with a boiling point of 120° C. or less may be used. Furthermore, auxiliary agents may be incorporated into the remoistening solution. Examples of the auxiliary agents include ink fixing agents, pigment-dispersing agents, thickening agents, singlet oxygen quenchers, hindered amine light stabilizers, antioxidants, defoaming agents, ultraviolet absorbing agents, fluorescent whitening agents, water-resisting agents, discoloration prevention agents, antistatic agents, and mildew proofing agents.

Additionally, after the coating solution for the ink-absorbing layer is applied to the substrate, the coating compound containing the water-soluble zirconium salt may be applied without drying the coating solution for the ink-absorbing layer, followed by drying, so that the ink-absorbing layer 3 and the gloss-developing layer 4 are simultaneously formed.

The novel ink-jet recording sheet of the present invention described above has high glossiness and excellent ink absorbability, thereby enabling clear images with high resolution. Furthermore, excellent storage stability of images, such as light fastness and water resistance, and excellent coating strength are also exhibited.

Furthermore, in addition to the ink-absorbing layer and the gloss-developing layer, another layer may be provided as necessary, for example, a whiteness control layer for controlling the hue of the printing paper, or a back coating layer which prevents static build-up and stabilizes traveling.

In an image-forming method using the ink-jet recording sheet of the present invention, ink-jet inks containing water-soluble dyes or pigments are ejected from recording nozzles driven by an electric field, heat, pressure, or the like onto the gloss-developing layer of the ink-jet recording sheet. Images obtained by such an image-forming method are glossy and clear with high resolution. Moreover, excellent storage stability of images, such as light fastness and water resistance, is exhibited.

### EXAMPLES

The present invention will be described more specifically based on Examples and Comparative Examples below. It is to be understood that the present invention is not limited to such Examples.

In Examples and Comparative Examples, “%” means “percent by weight (based on solid content)” unless otherwise described. In each case, the content of the water-soluble zirconium salt is expressed by the weight in terms of ZrO₂. The average secondary particle size of the pigment is measured using a Coulter counter.

In the evaluation test described below, ink-jet recording to ink-jet recording sheets fabricated in Examples and Comparative Examples was conducted using an ink-jet printer BJ-F600 (manufactured by Canon Inc.).

### Examples 1 to 20

Ink-jet recording sheets, each including an ink-absorbing layer and a gloss-developing layer, shown in Table 1 were fabricated using coating solutions having the compositions described below.

The ink-absorbing layer and the gloss-developing layer were formed as follows.

(Ink-Absorbing Layer)

To a resin-coated paper (RC paper) with a weighing capacity of 170 g/m², one of the coating solutions X1 to X4 for an ink-absorbing layer shown below, which was prepared at a concentration of 16%, was applied in a coating amount of 25 g/m² (based on solid content) using a bar coater, followed by drying at 100° C. for 5 minutes. An ink-absorbing layer was thereby formed.

(Gloss-Developing Layer)

To the ink-absorbing layer, one of the coating solutions Y1 to Y14 for a gloss-developing layer shown below, which was prepared at a concentration so as to satisfy the coating amount, was applied in the coating amount shown in Table 1 (based on solid content) using a bar coater, followed by drying at 100° C. for 3 minutes. A gloss-developing layer was thereby formed.

Coating solution for ink-absorbing layer

| | |
|---|---|
| X1 | |
| QS30 (manufactured by Tokuyama Corp.: | 70% |
| silica produced by vapor phase process) | |
| GH20 (manufactured by Nippon Synthetic Chemical | 25% |
| Industry Co., Ltd.: polyvinyl alcohol) | |
| PAS-H-5L (manufactured by Nitto Boseki Co., Ltd.: | 5% |
| polydiallylamine polymer) | |
| X2 | |
| QS30 (manufactured by Tokuyama Corp.: | 65% |
| silica produced by vapor phase process) | |
| GH20 (manufactured by Nippon Synthetic Chemical | 24% |
| Industry Co., Ltd.: polyvinyl alcohol) | |
| E2000 (manufactured by Dai-ichi Kogyo Seiyaku Co., | 6% |
| Ltd. : polyurethane resin dispersant) | |
| PAS-H-5L (manufactured by Nitto Boseki Co., Ltd.: | 5% |
| polydiallylamine polymer) | |
| X3 | |
| Al₂O₃—C (manufactured by Nippon Aerosil Co., Ltd.: | 75% |
| alumina produced by vapor phase process) | |
| GH20 (manufactured by Nippon Synthetic Chemical | 25% |
| Industry Co., Ltd.: polyvinyl alcohol) | |
| X4 | |
| QS30 (manufactured by Tokuyama Corp.: | 70% |
| silica produced by vapor phase process) | |
| GH20 (manufactured by Nippon Synthetic Chemical | 15% |
| Industry Co., Ltd.: polyvinyl alcohol) | |
| E2000 (manufactured by Dai-ichi Kogyo Seiyaku Co., | 10% |
| Ltd.: polyurethane resin dispersant | |
| PAS-H-5L (manufactured by Nitto Boseki Co., Ltd.: | 5% |
| polydiallylamine polymer) | |

Coating solution for gloss-developing layer

| | |
|---|---|
| Y1 | |
| AZCOTE 5800M (manufactured by Hopton Technologies | 100% |
| Inc.: ammonium zirconium carbonate) | |
| Y2 | |
| Zircosol ZN (manufactured by Daiichi Kigenso Kagaku | 100% |
| Kogyo Co., Ltd.: zirconium nitrate) | |
| Y3 | |
| Zirconium sulfate (manufactured by Daiichi Kigenso | 100% |
| Kagaku Kogyo Co., Ltd.) | |
| Y4 | |
| Zirconium acetate (manufactured by Daiichi Kigenso | 100% |
| Kagaku Kogyo Co., Ltd.) | |
| Y5 | |
| Zirconium oxychloride (manufactured by Daiichi | 100% |
| Kigenso Kagaku Kogyo Co., Ltd.) | |
| Y6 | |
| AZCOTE 5800M (manufactured by Hopton Technologies | 75% |
| Inc.: ammonium zirconium carbonate) | |
| Al₂O₃—C (manufactured by Nippon Aerosil Co., | 25% |
| Ltd.: alumina with average secondary | |
| particle size of 0.4 μm produced by | |
| vapor phase process) | |
| Y7 | |
| AZCOTE 5800M (manufactured by Hopton Technologies | 50% |
| Inc.: ammonium zirconium carbonate) | |
| Al₂O₃—C (manufactured by Nippon Aerosil Co., | 50% |
| Ltd.: alumina with average secondary | |
| particle size of 0.4 μm produced by | |
| vapor phase process) | |
| Y8 | |
| AZCOTE 5800M (manufactured by Hopton Technologies | 75% |
| Inc.: ammonium zirconium carbonate) | |
| P527 (manufactured by Mizusawa Industrial | 25% |
| Chemicals, Ltd.: synthetic silica with average | |
| secondary particle size of 1.6 μm) | |
| Y9 | |
| AZCOTE 5800M (manufactured by Hopton Technologies | 75% |
| Inc.: ammonium zirconium carbonate) | |
| X-37 (manufactured by Tokuyama Corp.: synthetic | 25% |
| silica with average secondary particle size | |
| of 2.9 μm) | |
| Y10 | |
| AZCOTE 5800M (manufactured by Hopton Technologies | 50% |
| Inc.: ammonium zirconium carbonate) | |
| Al₂O₃—C (manufactured by Nippon Aerosil Co., | 25% |
| Ltd.: alumina with average secondary | |
| particle size of 0.4 μm produced by | |
| vapor phase process) | |
| GH20 (manufactured by Nippon Synthetic Chemical | 25% |
| Industry Co., Ltd.: polyvinyl alcohol) | |
| Y11 | |
| AZCOTE 5800M (manufactured by Hopton Technologies | 50% |
| Inc.: ammonium zirconium carbonate) | |
| SNOWTEX PS-M (manufactured by Nissan Chemical | 10% |
| Industries, Ltd.: colloidal silica with | |
| average secondary particle size of 0.1 μm) | |
| GH20 (manufactured by Nippon Synthetic Chemical | 40% |
| Industry Co., Ltd.: polyvinyl alcohol) | |
| Y12 | |
| AZCOTE 5800M (manufactured by Hopton Technologies | 90% |
| Inc.: ammonium zirconium carbonate) | |
| GH20 (manufactured by Nippon Synthetic Chemical | 10% |
| Industry Co., Ltd.: polyvinyl alcohol) | |
| Y13 | |
| Zirgel K (manufactured by Nippon Light Metal Co., | 100% |
| Ltd.: potassium zirconium carbonate) | |
| Y14 | |
| Zirgel K (manufactured by Nippon Light Metal Co., | 75% |
| Ltd.: potassium zirconium carbonate) | |
| Al₂O₃—C (manufactured by Nippon Aerosil Co., | 25% |
| Ltd.: alumina with average secondary | |
| particle size of 0.4 μm produced by | |
| vapor phase process) | |

### Comparative Examples 1 to 12

Ink-jet recording sheets, each including an ink-absorbing layer and a gloss-developing layer, shown in Table 1 were fabricated using coating solutions having the compositions described below. However, in Comparative Example 1, no gloss-developing layer was provided.

The ink-absorbing layer and the gloss-developing layer were formed as follows.

(Ink-Absorbing Layer)

The ink-absorbing layers were formed in the same manner as that in Examples 1 to 20 except that the coating solution X4 was used in Comparative Examples 1 to 10 and 12 and that a coating solution X5 described below was used in Comparative Example 11.

(Gloss-Developing Layer)

The gloss-developing layers were formed on the ink-absorbing layers in the same manner as that in Examples 1 to 20 except that coating solutions Y15 to Y21 descried below were used.

Coating solution for ink-absorbing layer

| | |
|---|---|
| X5 | |
| AZ200 (manufactured by Nippon Silica Industry | 70% |
| Co., Ltd.: silica produced by gel method) | |
| GH20 (manufactured by Nippon Synthetic Chemical | 10% |
| Industry Co., Ltd.: polyvinyl alcohol) | |
| E2000 (manufactured by Dai-ichi Kogyo Seiyaku Co., | 15% |
| Ltd.: polyurethane resin dispersant) | |
| PAS-H-5L (manufactured by Nitto Boseki Co., Ltd.: | 5% |
| polydiallylamine polymer) | |

Coating solution for gloss-developing layer

| | |
|---|---|
| Y15 | |
| Zirconium stearate (manufactured by Daiichi | 100% |
| Kigenso Kagaku Kogyo Co., Ltd.) | |
| Y16 | |
| Zirconium hydroxide (manufactured by Daiichi | 75% |
| Kigenso Kagaku Kogyo Co., Ltd.) | |
| BY-001 (manufactured by Nippon Silica Industry Co., | 25% |
| Ltd.: silica with average secondary particle | |
| size of 14 μm produced by gel method) | |
| Y17 | |
| Zircosol AC2 (manufactured by Daiichi Kigenso Kagaku | 40% |
| Kogyo Co., Ltd.: zirconium oxychloride) | |
| SNOWTEX PS-M (manufactured by Nissan Chemical | 60% |
| Industries, Ltd.: colloidal silica with | |
| average secondary particle size of 0.1 μm) | |
| Y18 | |
| Zircosol ZN (manufactured by Daiichi Kigenso Kagaku | 10% |
| Kogyo Co., Ltd.: zirconium nitrate) | |
| GH20 (manufactured by Nippon Synthetic Chemical | 90% |
| Industry Co., Ltd.: polyvinyl alcohol) | |
| Y19 | |
| Zircosol ZN (manufactured by Daiichi Kigenso Kagaku | 40% |
| Kogyo Co., Ltd.: zirconium nitrate) | |
| GH20 (manufactured by Nippon Synthetic Chemical | 60% |
| Industry Co., Ltd.: polyvinyl alcohol) | |
| Y20 | |
| Zircosol ZN (manufactured by Daiichi Kigenso Kagaku | 15% |
| Kogyo Co., Ltd.: zirconium nitrate) | |
| SNOWTEX PS-M (manufactured by Nissan Chemical | 60% |
| Industries, Ltd.: colloidal silica with | |
| average secondary particle size of 0.1 μm) | |
| GH20 (manufactured by Nippon Synthetic Chemical | 25% |
| Industry Co., Ltd.: polyvinyl alcohol) | |
| Y21 | |
| SNOWTEX PS-M (manufactured by Nissan Chemical | 80% |
| Industries, Ltd.: colloidal silica with | |
| average secondary particle size of 0.1 μm) | |
| GH20 (manufactured by Nippon Synthetic Chemical | 20% |
| Industry Co., Ltd.: polyvinyl alcohol) | |

Evaluation of Ink-Jet Recording Sheet

With respect to each of the ink-jet recording sheets in Examples 1 to 20 and Comparative Examples 1 to 12, specular gloss at an angle of 60 degrees, ink absorbability, light fastness, water resistance, and coating strength were evaluated based on the criteria described below. The results thereof are shown in Table 1.

Glossiness

In accordance with JIS Z8741-1997, the specular gloss at an angle of 60 degrees was measured at 7 points in each ink-jet recording sheet, using a glossmeter VG2000 (manufactured by Nippon Denshoku Industries Co., Ltd.), and the glossiness was graded into ranks based on the following evaluation criteria.

Rank Criteria
A: The glossiness at 60 degrees was 70% or more.
B: The glossiness at 60 degrees was 50% to less than 70%.
C: The glossiness at 60 degrees was 30% to less than 50%.
D: The Glossiness at 60 degrees was less than 30%.
   Ink Absorbability

Each ink-jet recording sheet was printed with two overlapping color inks, and the absorption state was observed with a microscope. A paper was contact-bonded to the ink-jet recording sheet immediately after printing at a load of 50 g/cm², and transferring of ink was visually observed. The ink absorbability was graded into ranks based on the following evaluation criteria.

Rank Criteria
A: The boundaries between printed areas were clear, and ink was not transferred to the paper.
B: The boundaries between printed areas were clear, but ink was slightly transferred to the paper.
C: Either the boundaries between printed areas was unclear or a lot of ink transferred to the paper.
D: The boundaries between printed areas were unclear, and a lot of ink transferred to the paper.

Light Fastness

Each ink-jet recording sheet was printed using magenta ink with 16 tones, and an area with an initial density of 1.0 when measured with a Macbeth densitometer was selected. The selected area was irradiated in an environment at 55° C./60% RH for 62 hours by a xenon fade-meter (manufactured by Atlas Co., Ltd.: Ci35A). The residual density ratio to the initial density was measured, and the light fastness was graded into ranks based on the following evaluation criteria.

Rank Criteria
A: The residual density ratio was 90% or more.
B: The residual density ratio was 80% to less than 90%.
C: The residual density ratio was 70% to less than 80%
D: The residual density ratio was less than 70%.
   Water Resistance

Each of yellow, magenta, cyan, and black ink was solidly printed on each ink-jet recording sheet, and the ink-jet recording sheet was immersed in pure water for 5 minutes. The dissolution of the printing materials into water was visually observed, and the water resistance was graded into ranks based on the following evaluation criteria.

Rank Criteria
A: No dissolution was observed.
B: Slight dissolution was observed, but no problem for practical use.
C: Dissolution and dyeing in non-printed areas were observed.
D: Considerable dissolution was observed, and the density of the printed area was decreased.
   Coating Strength

A commercially available adhesive cellophane tape was attached to the surface of the coating layer (the ink-absorbing layer in Comparative Example 12 and the gloss-developing layer in the others) of each ink-jet recording sheet. The detachment status of the coating layer was visually observed when the adhesive cellophane tape was peeled off 5 minutes later. The coating strength was graded into ranks based on the following evaluation criteria.

Rank Criteria
A: The coating layer was not detached.
B: The coating layer was slightly detached, but no problem in practical use.
C: The coating layer was detached at 10% or more of the total adhesion area, but no problem in practical use.

D: The coating layer was considerably detached, resulting in a problem in practical use.

TABLE 1

| | | Layer Y (gloss-developing layer) | | | | | | | | | | | |
|---|---|---|---|---|---|---|---|---|---|---|---|---|---|
| | | | | | | Addi- | | | | | | | |
| | Layer | | | Water | (Zr) | tion | Relation | | Evaluation results | | | | |
| | X* | | Zirconium | solu- | con- | of | between | Coating | | Ink | Light | Water | |
| | Compo- | Compo- | compound | bility | tent** | Binder | (Zr) and | amount | Glossi- | absorb- | fast- | resis- | coating |
| | sition | sition | (Zr) | of (Zr) | (%) | (B) | (B) | (g/m²) | ness | ability | ness | tance | strength |
| Example | X1 | Y1 | Ammonium | Soluble | 100 | No | — | 0.5 | A | B | A | A | A |
| 1 | | | zirconium | | | | | | | | | | |
| | | | carbonate | | | | | | | | | | |
| Example | X1 | Y2 | Zirconium | Soluble | 100 | No | — | 0.5 | B | B | A | A | A |
| 2 | | | nitrate | | | | | | | | | | |
| Example | X1 | Y3 | Zirconium | Soluble | 100 | No | — | 0.5 | B | B | B | A | A |
| 3 | | | sulfate | | | | | | | | | | |
| Example | X1 | Y4 | Zirconium | Soluble | 100 | No | — | 0.5 | B | B | B | A | B |
| 4 | | | acetate | | | | | | | | | | |
| Example | X1 | Y5 | Zirconium | Soluble | 100 | No | — | 0.5 | B | B | B | B | B |
| 5 | | | oxychloride | | | | | | | | | | |
| Example | X1 | Y6 | Ammonium | Soluble | 75 | No | — | 0.05 | B | A | B | B | B |
| 6 | | | zirconium | | | | | | | | | | |
| | | | carbonate | | | | | | | | | | |
| Example | X1 | Y6 | Ammonium | Soluble | 75 | No | — | 0.5 | A | A | A | A | A |
| 7 | | | zirconium | | | | | | | | | | |
| | | | carbonate | | | | | | | | | | |
| Example | X1 | Y6 | Ammonium | Soluble | 75 | No | — | 2 | A | A | A | A | A |
| 8 | | | zirconium | | | | | | | | | | |
| | | | carbonate | | | | | | | | | | |
| Example | X1 | Y6 | Ammonium | Soluble | 75 | No | — | 4.5 | B | A | A | B | B |
| 9 | | | zirconium | | | | | | | | | | |
| | | | carbonate | | | | | | | | | | |
| Example | X1 | Y7 | Ammonium | Soluble | 50 | No | — | 0.5 | A | A | B | B | B |
| 10 | | | zirconium | | | | | | | | | | |
| | | | carbonate | | | | | | | | | | |
| Example | X1 | Y8 | Ammonium | Soluble | 75 | No | — | 0.5 | A | A | A | A | A |
| 11 | | | zirconium | | | | | | | | | | |
| | | | carbonate | | | | | | | | | | |
| Example | X1 | Y9 | Ammonium | Soluble | 75 | No | — | 0.5 | A | A | A | A | A |
| 12 | | | zirconium | | | | | | | | | | |
| | | | carbonate | | | | | | | | | | |
| Example | X1 | Y10 | Ammonium | Soluble | 50 | Yes | (Zr) > (B) | 0.5 | B | B | B | B | B |
| 13 | | | zirconium | | | | | | | | | | |
| | | | carbonate | | | | | | | | | | |
| Example | X1 | Y11 | Ammonium | Soluble | 50 | Yes | (Zr) > (B) | 0.5 | B | B | B | B | A |
| 14 | | | zirconium | | | | | | | | | | |
| | | | carbonate | | | | | | | | | | |
| Example | X1 | Y12 | Ammonium | Soluble | 90 | Yes | (Zr) > (B) | 0.5 | A | B | A | B | A |
| 15 | | | zirconium | | | | | | | | | | |
| | | | carbonate | | | | | | | | | | |
| Example | X2 | Y6 | Ammonium | Soluble | 75 | No | — | 0.5 | A | A | A | A | A |
| 16 | | | zirconium | | | | | | | | | | |
| | | | carbonate | | | | | | | | | | |
| Example | X3 | Y6 | Ammonium | Soluble | 75 | No | — | 0.5 | A | A | A | A | B |
| 17 | | | zirconium | | | | | | | | | | |
| | | | carbonate | | | | | | | | | | |
| Example | X4 | Y6 | Ammonium | Soluble | 75 | No | — | 0.5 | A | A | A | B | B |
| 18 | | | zirconium | | | | | | | | | | |
| | | | carbonate | | | | | | | | | | |
| Example | X1 | Y13 | Potassium | Soluble | 100 | No | — | 0.5 | A | B | A | A | A |
| 19 | | | zirconium | | | | | | | | | | |
| | | | carbonate | | | | | | | | | | |
| Example | X1 | Y14 | Potassium | Soluble | 75 | No | — | 0.5 | A | A | A | A | A |
| 20 | | | zirconium | | | | | | | | | | |
| | | | carbonate | | | | | | | | | | |
| C. Ex. 1 | X4 | none | — | — | — | | — | none | D | A | D | C | B |
| C. Ex. 2 | X4 | Y15 | Zirconium | Insoluble | 100 | No | — | 0.5 | D | D | C | C | D |
| | | | stearate | | | | | | | | | | |
| C. Ex. 3 | X4 | Y16 | Zirconium | Insoluble | 75 | No | — | 0.5 | D | D | C | C | D |
| | | | hydroxide | | | | | | | | | | |
| C. Ex. 4 | X4 | Y17 | Zirconium | Soluble | 40 | No | — | 0.5 | C | B | C | B | D |
| | | | oxychloride | | | | | | | | | | |
| C. Ex. 5 | X4 | Y18 | Zirconium | Soluble | 10 | Yes | (Zr) < (B) | 0.5 | B | D | C | D | A |
| | | | nitrate | | | | | | | | | | |
| C. Ex. 6 | X4 | Y19 | Zirconium | Soluble | 40 | Yes | (Zr) < (B) | 0.5 | B | D | B | D | B |
| | | | nitrate | | | | | | | | | | |
| C. Ex. 7 | X4 | Y19 | Zirconium | Soluble | 40 | Yes | (Zr) < (B) | 0.025 | D | C | C | C | C |
| | | | nitrate | | | | | | | | | | |
| C. Ex. 8 | X4 | Y19 | Zirconium | Soluble | 40 | Yes | (Zr) < (B) | 5 | D | D | B | C | D |
| | | | nitrate | | | | | | | | | | |
| C. Ex. 9 | X4 | Y20 | Zirconium | Soluble | 15 | Yes | (Zr) < (B) | 0.5 | D | B | D | C | D |
| | | | nitrate | | | | | | | | | | |
| C. Ex. | X4 | Y21 | none | — | — | — | — | 0.5 | D | B | D | C | D |
| 10 | | | | | | | | | | | | | |
| C. Ex. | X5 | Y17 | Zirconium | Soluble | 40 | No | — | 0.5 | C | A | B | D | D |
| 11 | | | oxychloride | | | | | | | | | | |
| C. Ex. | X4 | Y19 | Zirconium | Soluble | 40 | Yes | (Zr) < (B) | 0.5 | D | D | C | D | B |
| 12 | | | nitrate | | | | | | | | | | |

Note:
C. Ex. stands for Comparative Example.
*Layer X corresponds to ink-absorbing layer.
**(Zr) content in terms of ZrO₂ in total solids

As is obvious from Table 1, in accordance with the present invention (Examples 1 to 20), each ink-jet recording sheet includes at least one ink-absorbing layer disposed on a substrate and a gloss-developing layer as the outermost layer, the gloss-developing layer contains a water-soluble zirconium salt, the content of the water-soluble zirconium salt, in terms of ZrO₂, being 10% by weight or more of the total solids in the gloss-developing layer, and the gloss-developing layer optionally contains a binder resin in an amount not exceeding the zirconium salt content in terms of ZrO₂. Consequently, the ink-jet recording sheet has excellent glossiness and ink absorbability, excellent storage stability of images, such as light fastness and water resistance, and satisfactory coating strength.

In contrast, with respect to the ink-jet recording sheets in Comparative Examples 1 to 12, in which the contents of water-soluble zirconium salts are out of the range of the present invention, it is not possible to obtain satisfactory glossiness and ink absorbability simultaneously, and either storage stability, such as light fastness and water resistance, or coating strength is unsatisfactory.

As described above, the ink-jet recording sheet of the present invention has excellent glossiness and ink absorbability, and it is possible to form images having excellent storage stability, such as light fastness and water resistance.

1. An ink-jet recording sheet comprising:
an ink-absorbing layer disposed on a substrate; and
a gloss-developing layer disposed on the ink-absorbing layer, the gloss-developing layer containing a water-soluble zirconium salt as a principal ingredient,
wherein the content of the water-soluble zirconium salt, in terms of ZrO2, is 10% by weight or more of the total solids in the gloss-developing layer, and the gloss-developing layer optionally contains a binder resin in an amount not exceeding the zirconium salt content in terms of ZrO2.

2. An ink-jet recording sheet comprising:
an ink-absorbing layer disposed on a substrate; and
a gloss-developing layer disposed on the ink-absorbing layer, the gloss-developing layer being formed by applying a coating compound containing a water-soluble zirconium salt onto the ink-absorbing layer, followed by drying,
wherein the content of the water-soluble zirconium salt, in terms of ZrO2, is 10% by weight or more of the total solids in the coating compound, and the coating compound optionally contains a binder resin in an amount not exceeding the zirconium salt content in terms of ZrO2.

3. An ink-jet recording sheet according to either claim 1 or 2, wherein the specular gloss at an angle of 60 degrees according to Japanese Industrial Standard (JIS) Z8741 is 50% or more in the gloss-developing layer.

4-5. (canceled)

6. An ink-jet recording sheet according to either claim 1 or 2, wherein the water-soluble zirconium salt is an oxo acid salt of zirconium.

7. An ink-jet recording sheet according to either claim 1 or 2, wherein the water-soluble zirconium salt is at least one compound selected from the group consisting of ammonium zirconium carbonate, potassium zirconium carbonate, and zirconium nitrate.

8. An ink-jet recording sheet according to either claim 1 or 2, wherein the saturated aqueous solution of the water-soluble zirconium salt is alkaline.

9. An ink-jet recording sheet according to claim 2, wherein the gloss-developing layer is formed by applying the coating compound at a rate of 0.05 to 4.5 g/m2 on dry weight basis.

10. An ink-jet recording sheet according to either claim 1 or 2, wherein the ink-absorbing layer contains a water-soluble resin which reacts with the water-soluble zirconium salt, the content of the water-soluble resin being 80% by weight or more of the total resin content in the ink-absorbing layer.

11. An ink-jet recording sheet according to claim 10, wherein the water-soluble resin is polyvinyl alcohol.

12. An ink-jet recording sheet according to either claim 1 or 2, wherein the ink-absorbing layer comprises at least one ink-absorbable pigment selected from the group consisting of porous silica and porous alumina.

13. An ink-jet recording sheet according to claim 12, wherein the silica is fumed silica produced by a vapor phase process.

14. An ink-jet recording sheet according to claim 12, wherein the alumina is fumed alumina produced by a vapor phase process.

15-17. (canceled)
